(19) United States
(12) Patent Application Publication
(10) Pub. No.: US 2023/0351624 A1
(43) Pub. Date: Nov. 2, 2023

(54) ESTIMATING DEPTH FOR IMAGE AND RELATIVE CAMERA POSES BETWEEN IMAGES

(71) Applicant: HUAWEI TECHNOLOGIES CO., LTD., Shenzhen (CN)

(72) Inventors: Patrick RUHKAMP, Munich (DE); Onay Urfalioglu, Munich (DE)

(73) Assignee: HUAWEI TECHNOLOGIES CO., LTD., Shenzhen (CN)

(21) Appl. No.: 18/331,174

(22) Filed: Jun. 8, 2023

Related U.S. Application Data
(63) Continuation of application No. PCT/EP2020/085061, filed on Dec. 8, 2020.

(51) Int. Cl. G06T 3/00; G06T 7/70; G06T 3/40; G06T 7/55; G06T 7/11

(52) U.S. Cl. CPC G06T 7/55; G06T 3/0012; G06T 3/4007; G06T 7/11; G06T 7/70; G06T 2207/10016; G06T 2207/20081; G06T 2207/20084; G06T 2207/30244

(57) ABSTRACT

A computer implemented method of estimating depth for an image and relative camera poses between images in a video sequence, includes backwards warping the source image to generate a first reconstructed target image, and calculating an initial image reconstruction loss based on the target image and the first reconstructed target image. Forward warping the source depth map is performed to generate a second reconstructed target depth map, and an occlusion mask is generated based on the second reconstructed target depth map. The method further includes regularising the initial image reconstruction loss based on the generated occlusion mask. Thus, an occlusion aware method of image reconstruction is provided via a combination of forward and backward warping which identifies and masks occluded areas, and regularizes the image reconstruction loss.

### CROSS-REFERENCE TO RELATED APPLICATIONS

This application is a continuation of International Application No. PCT/EP2020/085061, filed on Dec. 8, 2020, the disclosure of which is hereby incorporated by reference in its entirety.

### TECHNICAL FIELD

The present disclosure relates generally to the field of computer vision and machine learning; and more specifically, to a computer implemented method of estimating depth for images and relative camera poses between images in a video sequence.

### BACKGROUND

In recent years, deep learning-based methods have enabled enhanced depth estimation. Such deep learning-based methods include self-supervised learning methods which enables a conventional convolutional neural network (CNN) to be trained without any ground truth for depth estimation. Further, the deep learning-based methods may be used for self-supervised depth and pose estimation from a monocular RGB-video without any ground truth annotations. Typically, by means of a correct depth and ego-motion estimation, an RGB image (colour image) from one view (such as a source image) can be backward warped into another view (such as a target image), such that the warped image and the original target image should be identical. This is however not achieved in practice due to various reasons, such as occlusions, moving objects, and the like. In other words, due to different effects, the reconstructed image is not perfect, as for instance due to occlusions. Presently, this problem of occlusion is solved by either learning the occluded regions in the image with a CNN or computing an image reconstruction loss from multiple points of view and then taking the minimum pixel-wise error of all views, referred to as minimum re-projection error. However, learning the occluded regions requires many additional parameters that need to be learned, which makes the process computationally complex, inefficient, and error-prone. The minimum re-projection error does not explicitly consider geometrical constraints and may be further disadvantageous due to different effects, such as reflecting object surfaces and other image properties, which may lead to wrong minimum re-projection errors where the occlusion does not actually occur.

Therefore, in light of the foregoing discussion, there exists a need to overcome the aforementioned drawbacks associated with regularization of occluded regions in training of neural networks.

### SUMMARY

The present disclosure seeks to provide computer implemented method of estimating depth for images and relative camera poses between images in a video sequence. The present disclosure seeks to provide a solution to the existing problem of occlusion in image reconstruction which affects image reconstruction loss and further training of neural networks. An aim of the present disclosure is to provide a solution that overcomes at least partially the problems encountered in prior art, and provide an occlusion aware method of image reconstruction via a combination of forward and backward warping which masks the occluded areas and regularizes the image reconstruction loss.

The object of the present disclosure is achieved by the solutions provided in the enclosed independent claims. Advantageous implementations of the present disclosure are further defined in the dependent claims.

In one aspect, the present disclosure provides a computer implemented method of estimating depth for an image and relative camera poses between images in a video sequence. The method comprises estimating a target depth map for a target image in a time series of two or more images. The method further comprises estimating a pose transformation from the target image to a source image adjacent to the target image in the time series. The method further comprises backwards warping the source image to generate a first reconstructed target image, based on the pose transformation between the adjacent images and the target depth map. The method further comprises calculating an initial image reconstruction loss, based on the target image and the first reconstructed target image. The method further comprises estimating a source depth map for the source image. The method further comprises forward warping the source depth map to generate a second reconstructed target depth map, based on the pose transformation and the source depth map. The method further comprises generating an occlusion mask based on the second reconstructed target depth map, indicating one or more occluded areas of the target image. The method further comprises regularising the initial image reconstruction loss based on the generated occlusion mask.

The method of the present disclosure provides an occlusion aware regularization of the image reconstruction loss. The method executes forward warping based on the pose transformation and the source depth map in addition to just backward warping of the source image executed by conventional methods. Thus, the present method can identify image regions where violations of image reconstruction will occur (or occurs) due to occlusions from foreground objects. Further, these identified image regions are used to mask and regularize the image reconstruction loss. Thus, the present method improves the image reconstruction loss and facilitates training of neural networks used for depth and ego-motion estimation. As a result, improved results for depth and ego-motion estimation are achieved.

In an implementation form, estimating the target depth map and the source depth map uses a first neural network. The first neural network when trained is used for accurately and continuously estimating depth with no or very less human intervention. Improved results for depth and ego-motion estimation are achieved using the method.

In a further implementation form, the method further comprises training the first neural network based on the regularised reconstruction loss.

The trained first neural network based on the regularised reconstruction loss provides improved results for depth estimation in comparison to conventional loss formulation.

In a further implementation form, estimating the pose transformation uses a second neural network.

The second neural network when trained is used for accurately and continuously estimating pose transformation with no or very less human intervention.

In a further implementation form, the method further comprises training the second neural network based on the regularised image reconstruction loss.

The trained second neural network based on the regularised reconstruction loss provides improved results for ego-motion (i.e., a pose) estimation in comparison to conventional loss formulation.

The forward warping enables in generating occlusion mask based on the second reconstructed target depth map. The occlusion mask indicates one or more occluded areas of the target image. These occluded areas are further excluded for calculating the image reconstruction loss. Thus, the initial image reconstruction loss is regularised.

In a further implementation form, the backward warping comprises projecting a plurality of target pixel locations of the target image into a 3D space, based on the target depth map and a set of camera intrinsic parameters. The backward warping further comprises transforming positions of the projected pixel locations to the source image, based on the pose transformation. The backward warping further comprises mapping pixel values of the source image onto the pixel locations in the reconstructed target image and generating the first reconstructed target image based on the mapped pixel values.

The backward warping is used for generating the first reconstructed target image. The first reconstructed target image when used with the second reconstructed target depth map enables in identifying the occluded areas which are then excluded when calculating the image reconstruction loss. Thus, enabling in achieving regularised image reconstruction loss.

In a further implementation form, mapping the pixel values of the source image onto the target pixel locations includes, if a transformed target pixel location does not fall into a pixel location of the source image, determining a pixel value using bilinear sampling of pixel values from adjacent pixel locations of the source image.

Bilinear sampling executes one-to-many mapping, which enables in mapping integer pixel location in the target image which have not fall into exact pixel location in source. One-to-many mapping enables determining the pixel value from adjacent pixel locations of the source image.

In a further implementation form, the forward warping comprises projecting a plurality of depth values from the source image into a 3D space, based on the source depth map and a set of camera intrinsic parameters. The forward warping further comprises generating a pose transformation from the source image to the target image by reversing the pose transformation from the target image to the source image. The forward warping further comprises transforming positions of the projected depth values, based on the pose transformation from the source image to the target image. The forward warping further comprises mapping the transformed depth values onto the second reconstructed target depth map based on the set of camera intrinsic parameters.

The forward warping is used for generating the second reconstructed target depth map. The second reconstructed target depth map when used with the first reconstructed target image enables in identifying the occluded areas which are then excluded when calculating the image reconstruction loss. Thus, enabling in achieving regularised image reconstruction loss.

In a further implementation form, mapping the transformed depth values onto the second reconstructed target depth map includes, if an occluded set of depth values are mapped onto a single pixel location of the second reconstructed target depth map, determining a minimum depth value from the occluded set of depth values and discarding the other depth values in the occluded set.

As multiple pixels may fall into the same pixel location in the second reconstructed target depth map, minimum scatter operation is executed to take the closest object in the reconstruction i.e., only minimum depth value, other depth values are discarded.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a functionality or step to be performed by external entities is not reflected in the description of a detailed element of that entity which performs that step or functionality, it should be clear for a skilled person that these methods and functionalities can be implemented in software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart of a method of estimating depth for an image and relative camera poses between images in a video sequence, in accordance with an embodiment of the present disclosure;

FIG. 2A is a block diagram of a system for estimating depth for an image and relative camera poses between images in a video sequence, in accordance with an embodiment of the present disclosure;

FIG. 2B is a block diagram that illustrates various exemplary components of a computing device for estimating depth for an image and relative camera poses between images in a video sequence, in accordance with an embodiment of the present disclosure;

FIG. 3 is a flowchart of exemplary operations of estimating depth for an image and relative camera poses between images in a video sequence, in accordance with an embodiment of the present disclosure;

FIG. 4 is an illustration of a time series of three images in a video sequence, in accordance with an embodiment of the present disclosure;

FIG. 5 is an illustration that illustrates exemplary operations of backwards warping a source image to generate a first reconstructed target image, in accordance with an embodiment of the present disclosure; and

FIG. 6 is an illustration that illustrates exemplary operations of forward warping a source depth map to generate a second reconstructed target depth map, in accordance with an embodiment of the present disclosure;

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

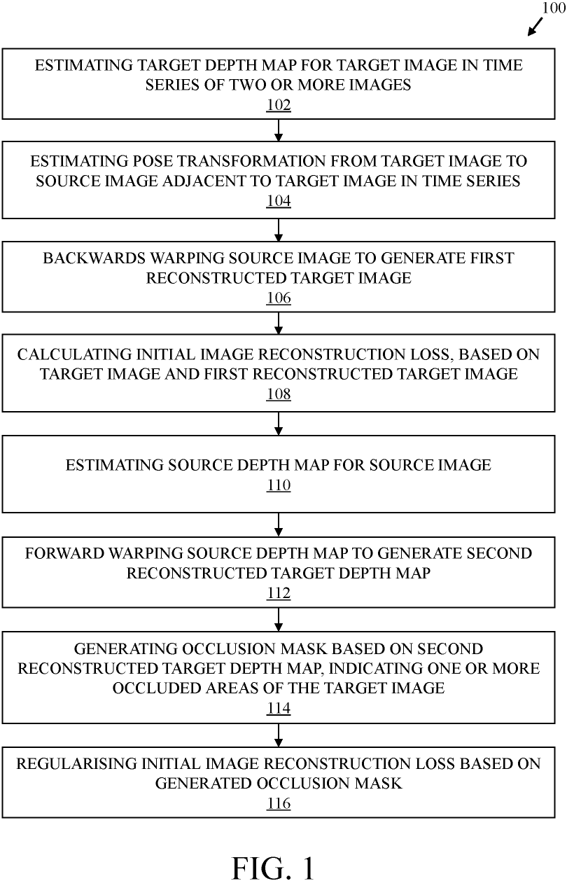

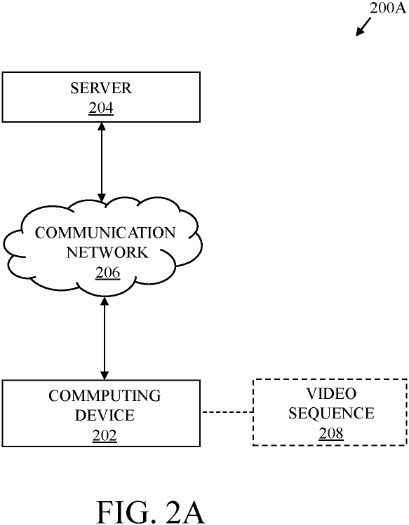

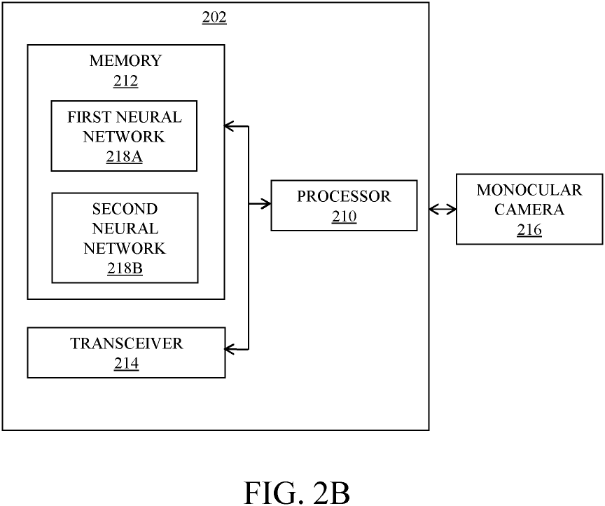

FIG. 1 is a flowchart of a method of estimating depth for an image and relative camera poses between images in a video sequence, in accordance with an embodiment of the present disclosure. With reference to FIG. 1, there is shown a method 100. The method 100 is executed at a computer device described, for example, in FIGS. 2A and 2B. The method 100 includes steps 102 to 116.

The present disclosure provides a computer implemented method 100 of estimating depth for an image and relative camera poses between images in a video sequence, comprising:
estimating a target depth map for a target image in a time series of two or more images;
estimating a pose transformation from the target image to a source image adjacent to the target image in the time series;
backwards warping the source image to generate a first reconstructed target image, based on the pose transformation and the target depth map;
calculating an initial image reconstruction loss, based on the target image and the first reconstructed target image;
estimating a source depth map for the source image;
forward warping the source depth map to generate a second reconstructed target depth map, based on the pose transformation and the source depth map;
generating an occlusion mask based on the second reconstructed target depth map, indicating one or more occluded areas of the target image; and
regularising the initial image reconstruction loss based on the generated occlusion mask.

At step 102, the method 100 comprises estimating a target depth map for a target image in a time series of two or more images. The target depth map is estimated for the target image by associating each pixel in the target image with a corresponding depth value. Each pixel of the target image may have different depths based on a location (i.e., closeness) with respect to a camera (i.e., a position of a camera). The depth map herein refers to a two-dimensional image/matrix where each pixel/element depicts a depth value of the corresponding three-dimensional point in a given image (such as the target image) with respect to a camera used for capturing the given image. Time series of two or more images here refers a video sequence captured by the camera comprising two or more images wherein the two or more images are associated with different time such as a current image is associated with time ‘t’, a next image is associated with time ‘t+1’, a previous image is associated with time ‘t-1’, and the like.

At step 104, the method 100 comprises estimating a pose transformation from the target image to a source image adjacent to the target image in the time series (e.g., from ‘t’ to ‘t+/-1’). The source image being adjacent to the target image refers to the source image being an image before or after the target image. In an example, target image is at time ‘t’ then the source image may be at time ‘t+1’ or ‘t-1’. In an example, transformation in pose includes transformation of position and orientation. In an example, 6DOF (6 degrees of freedom) transformation is used, where the pose transformation refers to transformation of three-dimensional translational elements and three angles for orientation of the camera pose of the target image to the camera pose of the source image.

At step 106, the method 100 comprises backwards warping the source image to generate a first reconstructed target image, based on the pose transformation and the target depth map. Backward warping includes a function to warp a pixel from source image (also referred to as source view) backwards into the target image (also referred to as target view) with known pose transformation, target depth map, and intrinsic camera parameters to generate the first reconstructed target image. Further, differentiability is obtained by bilinear sampling of pixel intensities in the source view.

According to an embodiment, backward warping comprises: projecting a plurality of target pixel locations of the target image into a 3D space, based on the target depth map and a set of camera intrinsic parameters. In other words, pixel locations of the plurality of pixels in the target image are projected into the three-dimensional space. The set of intrinsic camera parameters are the parameters used to describe a relationship between three-dimensional coordinates and two-dimensional coordinates of its projection onto an image plane. The intrinsic parameters are the parameters intrinsic to the camera capturing the image such as the optical, geometric, and digital characteristics of the camera. In an example, the intrinsic parameters include focal length, lens distortion, and principal point.

According to an embodiment, backward warping comprises transforming positions of the projected pixel locations to the source image, based on the pose transformation. The pose transformation, including the three-dimensional translational and three angles orientation of the camera, is used for transforming positions of the projected 3D coordinates into the camera view of the source image.

According to an embodiment, backward warping comprises mapping pixel values of the source image onto the corresponding target pixel locations and generating the first reconstructed target image based on the mapped pixel values. As a result of the mapping, an association between the pixel locations of desired reconstructed target image and the pixel values of the source image is obtained. Thus, target image is reconstructed to first reconstructed target image from the sampled pixel values.

According to an embodiment, mapping the pixel values of the source image onto the target pixel locations includes, if a transformed target pixel location does not fall into an integer pixel location in the source image, determining a pixel value using bilinear sampling of pixel values from adjacent pixel locations of the source image. The mapping of pixel values of the source image onto the target pixel location in the target image simply corresponds to projecting the pixel locations from the source image to the target image. One to many mapping is executed by, for example, bilinear sampling for mapping, as integer pixel location from the target image may not fall into exact pixel location in the source image, for example, pixel [15,20] in target image gets projectively transformed into [16.7, 23.8] in source image, which is not a valid pixel location as it is not an integer value, where each pixel location is described by their x and y coordinates on the image plane.

At step 108, the method 100 comprises calculating an initial image reconstruction loss, based on the target image and the first reconstructed target image. The initial image reconstruction loss is calculated based on a pixel-wise difference of the target image and the first reconstructed target image. In an example, the initial image reconstruction loss is calculated via a reconstruction loss algorithm employing a loss function which compares the first reconstructed target image with the original target image. There may be region(s) in the first reconstructed target image which are occluded. These regions are identified, and the first reconstructed target image is further regularized, i.e., reconstruction loss is regularised. This is explained in further steps of the present disclosure.

At step 110, the method 100 comprises estimating a source depth map for the source image. The source depth map is estimated for the source image by associating each pixel in the source image with a corresponding depth value. Each pixel of the source image may have different depths based on a location (i.e., a closeness) with respect to a camera. The source depth map herein refers to a two-dimensional image/matrix where each pixel/element depicts a depth of the corresponding three-dimensional point in the source image with respect to a camera used for capturing the source image.

At step 112, the method 100 comprises forward warping the source depth map to generate a second reconstructed target depth map, based on the pose transformation and the source depth map. Forward warping includes a function to warp a pixel from the source depth map into another target image by projectively transforming each pixel location into a second reconstructed target depth map based on pose transformation and source depth map. The forward warping is also referred to as splatting. The second reconstructed target depth map may also be referred to as a second projectively transformed depth map.

According to an embodiment, forward warping comprises: projecting a plurality of depth values from the source image into a 3D space, based on the source depth map and a set of camera intrinsic parameters. In other words, a pixel location with the camera intrinsic parameters and associated depth values is projected into the three-dimensional space.

According to an embodiment, forward warping comprises generating a pose transformation from the source image to the target image by reversing the pose transformation from the target image to the source image. The pose transformation generated here refers to transformation of three-dimensional translational elements and three angles for orientation from the source image to the target image.

According to an embodiment, forward warping comprises transforming positions of the projected depth values based on the pose transformation from the source image to the target image. The three-dimensional pixels are transformed with the aforesaid generated pose transformation.

According to an embodiment, forward warping comprises mapping the transformed depth values onto the second reconstructed target depth map based on the set of camera intrinsic parameters. In mapping the transformed depth values onto the second reconstructed target depth map there is no bilinear sampling that is executed as in backward warping, as each pixel is not to be associated, but the second reconstructed target depth map is directly reconstructed (each projected pixel is rounded to the nearest integer pixel location).

In an example, a function (1) represents a pixel of the source depth map mapped into world coordinates;

$${p}_{S}^{w} = {D}_{S} \left({p}_{S}\right) {K}^{- 1} {p}_{S} \qquad \text{(1)}$$

a function (2) represents the transformation from the source camera view to the target camera view by applying the relative pose between the views comprising of rotation and translation;

$${{p}^{′}}_{T}^{w} = {R}_{S \to T} {p}_{S}^{w} + {t}_{S \to T}$$

such that

$${p}_{S}^{w} ≡ {{p}^{′}}_{T}^{w} \qquad \text{(2)}$$

a function (3) represents transformation from 3D back to a 2D target camera coordinate frame; and

$${p}_{T} = K {p}_{T}^{w} \qquad \text{(3)}$$

a function (4) represents taking closest object and omit occluded ones in forward warping.

$${D}_{T} \left(i , j\right) = {min}_{x , y} z \left(x , y\right) \qquad \text{(4)}$$

wherein,
‘T’ refers to the target;
‘S’ refers to the source;
‘p’ refers to a point in the image (a pixel with x and y location);
‘D’ refers to a depth map;
‘K’ refers to a camera intrinsic;
‘W’ refers to 3D world coordinates;
‘R’ refers to rotation (3DOF); and
‘t’ refers to translation (3DOF).

According to an embodiment, mapping the transformed depth values onto the second reconstructed target depth map includes, if an occluded set of depth values are mapped onto a single pixel location of the second reconstructed target depth map, determining a minimum depth value from the occluded set of depth values and discarding the other depth values in the occluded set. As multiple pixels may fall into a same pixel location in the second reconstructed target depth map, a minimum depth value from the occluded set of depth values are determined and other depth values in the occluded set are discarded. In other words, a scatter minimum operation is executed to take the closest pixel in the reconstructed target depth map.

At step 114, the method 100 comprises generating an occlusion mask by the second reconstructed target depth map, indicating one or more occluded areas of the target image. The second reconstructed target depth map, reconstructed by forward warping of the source depth map into the target image, is utilized to detect occlusions that occur between the target image and the source image. In an example, occlusion mask is generated for those areas where background objects are occluded by the foreground objects. In an example, an occlusion mask may simply refer to identification of the occluded areas of the target image.

At step 116, the method 100 comprises regularising the initial image reconstruction loss based on the generated occlusion mask. The occlusion mask, generated based on the second reconstructed target depth map, is used along with the first reconstructed target image to regularise the image reconstruction loss. In an example, a target RGB (Red, Green, Blue) image, and a sampled RGB image that is reconstructed by backward warping a source RGB image with target depth map, can now be used to formulate the initial image reconstruction loss for training neural networks. The objective is to minimize the reconstruction error between the target RGB Image and the reconstructed RGB Image. Occlusions between the source and target images lead to artifacts in the RGB reconstruction during backward warping. The occlusion mask from the second reconstructed target depth map (from forward warping) is used to mask the areas in the final loss where artifacts due to occlusions occur. In other words, an occlusion aware regularization of the image reconstruction loss is achieved, where image regions are accurately identified where violations of image reconstruction will occur (or occurs) due to occlusions from foreground objects. As these identified image regions are used to mask and regularize the image reconstruction loss, the regularized image reconstruction loss is used for training of neural networks for depth and ego-motion estimation. This finds practical application in computer vision, for example, for autonomous driving applications, ADAS applications, visual odometry, and the like.

According to an embodiment, the method 100 further comprises training the first neural network based on the regularised reconstruction loss. The first neural network which is trained based on regularised reconstruction loss enables inaccurate depth estimation by the first neural network. Moreover, the method 100 further comprises training the second neural network based on the regularised image reconstruction loss. The second neural network (which is trained based on regularised reconstruction loss) enables inaccurate pose estimation by the second neural network. Thus, the first neural network and second neural network, when employed in advanced driver-assistance systems, self-driving vehicles, or robotics, for example, gives improved results in comparison to conventional neural networks. Once the trained first neural network and the second neural network is obtained, depth maps and pose estimations may be inferred.

According to an embodiment, in step 102, estimating the target depth map uses a first neural network. The trained first neural network is employed as a depth network. In an implementation, the first neural network may be a convolutional neural network (CNN), which is used for estimating the target depth map. Further, the source depth map also uses the first neural network. In an example, the first neural network for estimating the source depth map and the target depth map may be the same. Moreover, in step 104, estimating the pose transformation uses a second neural network. The second neural network may be employed as a pose network.

Thus, the method of the present disclosure can identify image regions where violations of the image reconstruction will occur due to occlusions from foreground objects. This information may be used to mask and regularize the image reconstruction loss. As a result, the method improves the image reconstruction loss and thus facilitates training, leading to improved results for depth and ego-motion estimation.

The steps 102 to 116 are only illustrative and other alternatives can also be provided where one or more steps are added, one or more steps are removed, or one or more steps are provided in a different sequence without departing from the scope of the claims herein.

FIG. 2A is a block diagram of a system for estimating depth for an image and relative camera poses between images in a video sequence, in accordance with an embodiment of the present disclosure. With reference to FIG. 2A there is shown a system 200A. The system 200A includes a computing device 202, a server 204, and a communication network 206. There is further shown a video sequence 208 processed by the computing device 202.

The computing device 202 may comprise suitable logic, circuitry, interfaces, and/or code that may be configured to communicate with the server 204, via the communication network 206. The computing device 202 further includes circuitry that is configured to estimate depth for the static image and relative camera poses between static images in the video sequence 208. Examples of the computing device 202 may include, but are not limited to, an imaging device (such as a camera or a camcorder), an image or video processing device, a motion capture system, an in-vehicle device, an electronic control unit (ECU) used in a vehicle, a projector device, or other computing devices.

The server 204 includes suitable logic, circuitry, interfaces, or code that is configured to store, process or transmit information to the computing device 202 via the communication network 206. Examples of the server include, but are not limited to a storage server, a cloud server, a web server, an application server, or a combination thereof.

The communication network 206 includes a medium (e.g., a communication channel) through which the server 204 communicates with the computing device 202. The communication network 206 may be a wired or wireless communication network. Examples of the communication network 206 may include, but are not limited to, a vehicle to everything (V2X), a Wireless Fidelity (Wi-Fi) network, a Local Area Network (LAN), a wireless personal area network (WPAN), a Wireless Local Area Network (WLAN), a wireless wide area network (WWAN), a cloud network, a Long Term Evolution (LTE) network, a Metropolitan Area Network (MAN), or the Internet. The server 204 and computing device 202 are potentially configured to connect to the communication network 206, in accordance with various wired and wireless communication protocols.

The video sequence 208 may comprise a sequence of images. The sequence of images may comprise at least a previous image and a current image that may include one or more objects, such as foreground and background objects. Examples of the object may include, but are not limited to a human subject, a group of people, an animal, an article, an item of inventory, a vehicle, and/or other such physical entity.

FIG. 2B is a block diagram that illustrates various exemplary components of a computing device for estimating depth for a static image and relative camera poses between static images in a video sequence, in accordance with an embodiment of the present disclosure. FIG. 2B is described in conjunction with elements form FIG. 2A. With reference to FIG. 2B, there is shown the computing device 202 (of FIG. 2A). The computing device 202 includes a processor 210, a memory 212, and a transceiver 214. The computing device 202 is coupled to a monocular camera 216. The memory 212 further includes a first neural network 218A and a second neural network 218B. Alternatively, the first neural network 218A and the second neural network 218B may be implemented as separate circuitry outside the memory 212) in the computing device 202.

The processor 210 is configured to receive the images in the video sequence from the monocular camera 216. In an implementation, the processor 210 is configured to execute instructions stored in the memory 212. In an example, the processor 210 may be a general-purpose processor. Other examples of the processor 210 may include, but are not limited to a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, or other processors or control circuitry. Moreover, the processor 210 may refer to one or more individual processors, processing devices, or a processing unit that is part of a machine, such as the computing device 202 (or an onboard computer of a vehicle).

The memory 212 includes suitable logic, circuitry, and interfaces that may be configured to store images of the video sequence. The memory 212 further stores instructions executable by the processor 210, the first neural network 218A and the second neural network 218B. Examples of implementation of the memory 212 may include, but are not limited to, Electrically Erasable Programmable Read-Only Memory (EEPROM), Random Access Memory (RAM), Read Only Memory (ROM), Hard Disk Drive (HDD), Flash memory, Solid-State Drive (SSD), or CPU cache memory. The memory 212 may store an operating system or other program products (including one or more operation algorithms) to operate the computing device 202.

The transceiver 214 includes suitable logic, circuitry, and interfaces that may be configured to communicate with one or more external devices, such as the servers 204. Examples of the transceiver 214 may include, but is not limited to, an antenna, a radio frequency (RF) transceiver, one or more amplifiers, one or more oscillators, a digital signal processor, a coder-decoder (CODEC) chipset, or a subscriber identity module (SIM) card.

The monocular camera 216 includes suitable logic, circuitry, and interfaces that may be configured to communicate with the computing device 202. The monocular camera 216 includes a single viewing tube where the lens is designed to capture the light from farther distances and amplify it, while a prism takes the image and inverts it. The monocular camera is used for precision spotting of target objects.

The first neural network 218A is employed as a depth network. In an implementation, the first neural network may be a convolutional neural network (CNN), which is used for estimating the depth maps, such as the target depth map and the source depth map. The second neural network 218B may also be referred to as a pose network, which is a separate network from the first neural network 218A. In an implementation, the second neural network 218B may be a convolutional neural network (CNN), which is used for estimating the pose transformation. The first neural network 218A and the second neural network 218B are trained together based on the regularised image reconstruction loss.

In operation, the processor 210 is configured to estimate a target depth map for a target image in a time series of two or more images. The processor 210 is further configured to estimate a pose transformation from the target image to a source image adjacent to the target image in the time series. The processor 210 is further configured to execute backwards warping of the source image to generate a first reconstructed target image based on the pose transformation and the target depth map. The processor 210 is further configured to calculate an initial image reconstruction loss, based on the target image and the first reconstructed target image. Further, the processor 210 is configured to estimate a source depth map for the source image and execute forward warping of the source depth map to generate a second reconstructed target depth map, based on the pose transformation and the source depth map. The processor 210 is further configured to generate an occlusion mask based on the second reconstructed target depth map, indicating one or more occluded areas of the target image, and regularise the initial image reconstruction loss based on the generated occlusion mask.

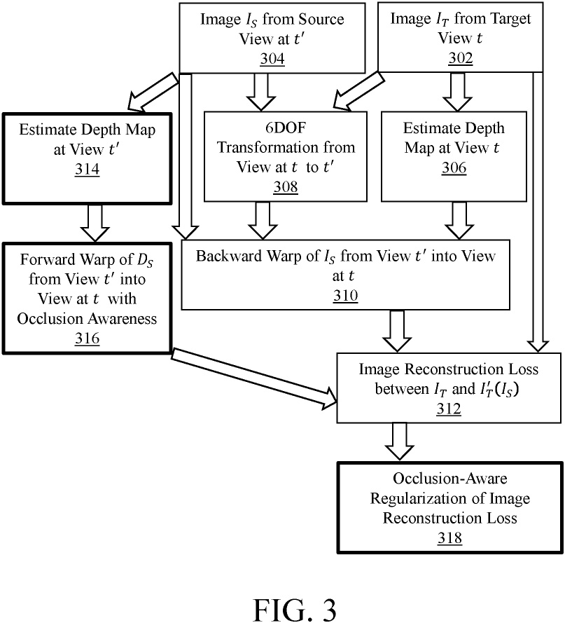

FIG. 3 is a flowchart of exemplary operations of estimating depth for an image and relative camera poses between images in a video sequence, in accordance with an embodiment of the present disclosure. With reference to FIG. 3, there is shown a flowchart 300 with operations 302 to 318.

At operation 302, image I_{T} from target view t is recieved by the processor 210 from the monocular camera 216. At operation 304, image Iₛ from source view at t′ is received by the processor 210 from the monocular camera 216, where t′ can be either t-1 or t+1. At operation 306, depth map is estimated at view t by the processor 210. At operation 308, 6DOF transformation from view at t to t′ is executed by the processor 210. At operation 310, backward warping of I_{S} from view t′ into view at t is executed by the processor 210. At operation 312, image reconstruction loss between

$${I}_{T} \text{and} {{I}^{′}}_{T} \left({I}_{S}\right)$$

is generated by the processor 210. At operation 314, a depth map at view t′ is estimated by the processor 210. At operation 316, forward warping of Dₛ from view t′ into view at t with occlusion awareness is executed by the processor 210. At operation 318, occlusion-aware regularization of image reconstruction loss is executed by the processor 210.

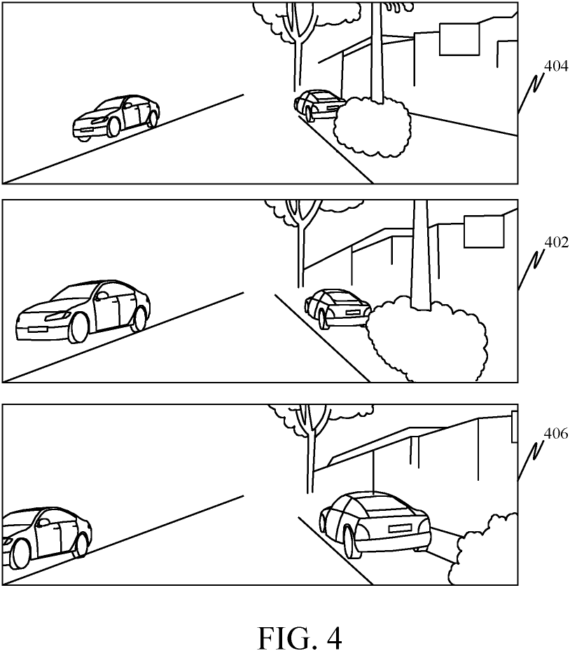

FIG. 4 is an illustration of a time series of three images in a video sequence in accordance with an embodiment of the present disclosure. There is shown a target image 402 at time ‘t’, a source image 404 at time ‘t-1’ and another source image 406 at time ‘t+1’. Each of the target image 402 and the source images 404 and 406 are images of a video sequence. In an example, the video sequence may be captured by the monocular camera 216 (of FIG. 2B), and thus the video sequence may be referred to as a monocular image sequence. Due to the objects in the foreground, for example, a pole with plants around it, in this case, the objects in the background, such as a car may be occluded, depending on camera movement. Hence, these areas in the scene cannot be correctly reconstructed by the backward warping to synthesize the reconstructed target image. In the FIG. 4, the video sequence (i.e., the monocular image sequence) is used to provide an overview of the training process for unsupervised depth and ego-motion estimation from the video sequence, where consecutive temporal frames (i.e., images in a time series of two or more consecutive images) provide the training input (i.e., loss signal). Two different neural networks (i.e., the first neural network 218A and the second neural network 218B) are trained using a monocular image sequence. The first neural network 218A is trained to estimate depth maps from a colour image, whereas the second neural network 218B is trained separately for pose estimations from the target image 402 to the source image 404 or 406 (adjacent to the target image 402 in the time series). For training, a convolutional neural network may be employed as the first neural network 218A. Similarly, for training the second neural network 218B, another CNN may be employed, which is trained using the regularised image reconstruction loss (described in FIG. 1), which improves the input and accordingly output results are improved, where the pose transformation estimation from the target image 402 to the source image 404 or 406 (i.e., pose estimation for relative camera transformations between adjacent views) is more accurate. The depth map at the target view (i.e., the target depth map for the target image 402 at time ‘t’) together with the transformations between the views (target and source image views) are then used to perform a backward warping of the source colour images (i.e., the source image 404 or 406) into the target view (i.e., the target image 402), whose difference serves as cost function (also sometimes referred to as a loss function or error function) for the training process, which is minimized iteratively during training. It is known that the cost function quantifies the error between predicted values and expected values and presents it in the form of a single real number, which is used to obtain a trained neural network. The second neural network 218B, which is trained based on regularised reconstruction loss, enables inaccurate pose estimation. Now, with accurate depth and pose estimates, the target view (i.e., the target image 402) can be reconstructed by backward warping the source images 404 and 406. The loss function for the neural networks (e.g., the CNN) is based on the image reconstruction and can be formulated to be the difference of the reconstructed image and the original target image. Occlusions, moving objects, a static camera, or objects moving at the same velocity as the camera, are a source of error for the reconstruction loss.

In contradiction to conventional systems, the trained first neural network 218A when in operation, is used not only to estimate a target depth map for a target image, such as the target image 402 at time ‘t’ in the time series of two or more consecutive images, but also to estimate a source depth map for the source image, such as the source image 404 at time ‘t+1’ and/or another source image 406 at time ‘t-1’. Each pixel in the source image 404 or 406 is associated with a corresponding depth in the training process in order to estimate the source depth map. Beneficially, the source depth map then is used to execute forward warping based on the pose transformation and the source depth map. Thus, image regions can be identified where violations of image reconstruction may occur due to occlusions from foreground objects. Further, these identified image regions are used to mask and regularize the image reconstruction loss, and thus, an occlusion aware regularization of the image reconstruction loss is achieved.

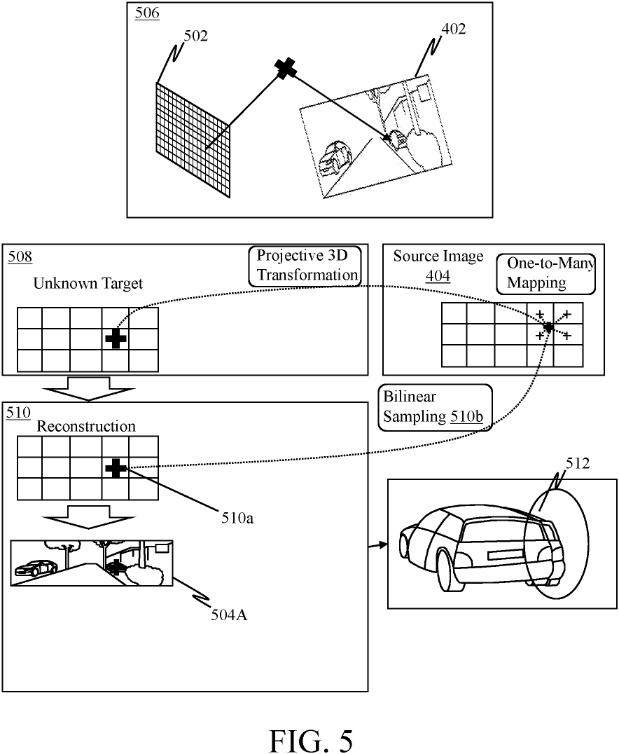

FIG. 5 is an illustration that illustrates exemplary operations of backwards warping a source image to generate a first reconstructed target image, in accordance with an embodiment of the present disclosure. FIG. 5 is described in conjunction with elements from FIG. 4. With reference to FIG. 5, there is shown operations 506, 508, and 510 for backwards warping of the source image 406 to generate a first reconstructed target image 504A, which is an RGB image. The backward warping refers to a function to reconstruct a target image (such as the target image 402) by sampling the RGB values from a source image, such as the source image 404 or 406. The sampled RGB values are referenced in the source image 404 or 406 by using projective geometry to associate each pixel from the target image 402 with a location in the source image 404 or 406 by using the operations 506, 508, and 510.

At operation 506, backward warping comprises projecting pixel location of the target image 402 (with known camera intrinsic parameters) and corresponding depth value of the target depth map into a three-dimensional space 502. The camera intrinsic parameters correspond to an optical centre and a focal length of the camera, such as the monocular camera 216.

At operation 508, backward warping comprises transforming positions of the projected pixel locations of the target image 402 to the source image 404 or 406, given the three-dimensional transformation (translation and rotation of the camera) i.e., pose transformation.

At operation 510, backward warping further comprises mapping pixel values of the source image 406 onto the transformed target pixel locations and generating the first reconstructed target image 504A based on the mapped pixel values. In other words, a reconstructed target pixel 510a is filled with sampled values from the source image 404 or 406. Moreover, a bilinear sampling 510b gives a weighted average of the closest four neighbouring pixels. As integer pixel location in the target image 402 may not fall into exact pixel location in source image 404 or 406 (e.g., Pixel at x-y-coordinates [15,20] in target may get projectively transformed into [16.7, 23.8] in the source image 404 or 406), the bilinear sampling 510b is performed. However, artifacts 512 may be introduced in reconstruction after bilinear sampling 510b, due to occlusions. Thus, forward warping is further executed to mask the occlusions.

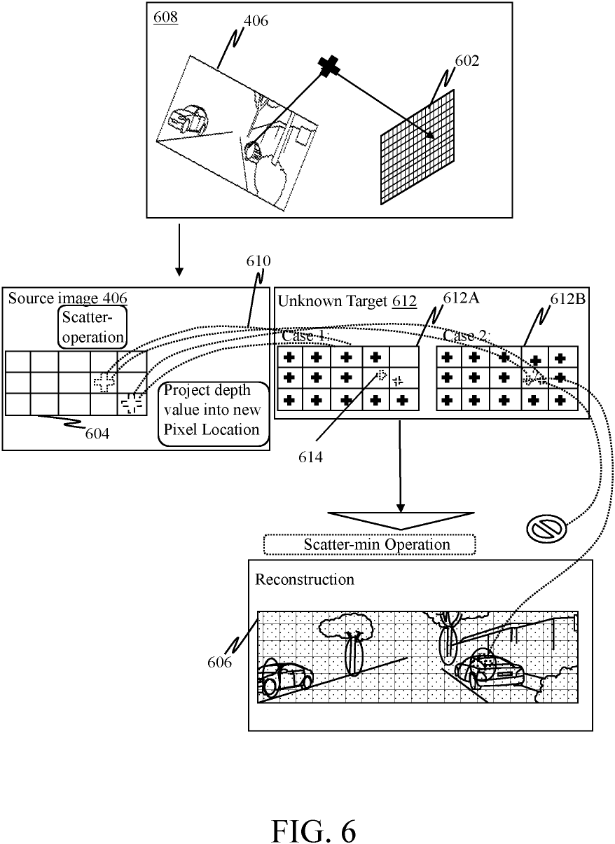

FIG. 6 is an illustration that illustrates exemplary operations of forward warping a source depth map to generate a second reconstructed target depth map in accordance with an embodiment of the present disclosure. FIG. 6 is described in conjunction with elements from FIG. 4. With reference to FIG. 6, there is shown operations 608 and 610 of forward warping that is a function to warp a pixel from a source view (e.g., the source image 406) into another target view by projectively transforming each pixel location into a new view (also known as splatting). There is further shown a three-dimensional space 602, a source depth map 604, and a second reconstructed target depth map 606. It is to be understood that the source depth map 604 and the second reconstructed target depth map 606 represent depth images (not be construed as colour images) and that are used for purpose of illustration to explain operations related to forward warping.

At operation 608, forward warping comprises projecting a plurality of depth values from the source image 406 into the three-dimensional space 602, based on the source depth map 604 and known camera intrinsic parameters.

At operation 610, forward warping comprises warping a pixel from the source depth map 604 into another target image (represented as unknown target 612) by projectively transforming each pixel location into another target image 612 (e.g., projective 3D geometry is used for projection of each pixel). This can also be referred to as a scatter operation. In this operation, there may be two scenarios, where in a first scenario 612A there are holes in constructed depth map, and in a second scenario 612B, due to many-to-one mapping (as shown in the FIG. 6), closest and distant object pixels (i.e., multiple pixels) may fall into same pixel location. The close and distant objects are with respect to camera position. Moreover, as multiple pixels may fall into the same pixel location, a minimum scatter operation is executed to take the closest object in the reconstruction. Thus, the second reconstructed target depth map 606 is formed based on the source depth map 604 and pose transformation. In this case, in the forward warping, background objects can be ignored, occlusions can be detected, and artifacts are thus removed.

The processor 210 is configured to calculate an initial image reconstruction loss based on the target image and the first reconstructed target image (reconstructed by backward warping the original source image with the original target depth map). Occlusions between different views (source image and target image) lead to artifacts in the RGB image reconstruction during backward warping. Thus, occlusion mask(s) generated from the reconstructed depth map from forward warping is used to mask these occluded areas in the final reconstruction loss.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A computer implemented method of estimating depth for an image and relative camera poses between images in a video sequence, comprising:
estimating a target depth map or a target image in a time series of two or more images;
estimating a pose transformation from the target image to a source image, adjacent to the target image in the time series;
backwards warping the source image to generate a first reconstructed target image, based on the pose transformation and the target depth map;
calculating an initial image reconstruction loss, based on the target image and the first reconstructed target image;
estimating a source depth map for the source image;
forward warping the source depth map to generate a second reconstructed target depth map, based on the pose transformation and the source depth map;
generating an occlusion mask by the second reconstructed target depth map, the occlusion map indicating one or more occluded areas of the target image; and
regularising the initial image reconstruction loss based on the generated occlusion mask to generate a regularised image reconstruction loss.

2. The method of claim 1, wherein the estimating the target depth map and the source depth map uses a first neural network.

3. The method of claim 1, further comprising training the first neural network based on the regularised image reconstruction loss.

4. The method of claim 1, wherein the estimating the pose transformation uses a second neural network.

5. The method of claim 4, further comprising training the second neural network based on the regularised image reconstruction loss.

6. The method of claim 1, the backwards warping comprising:
projecting a plurality of target pixel locations of the target image into a 3D space, based on the target depth map and a set of camera intrinsic parameters;
transforming positions of the projected pixel locations to the source image, based on the pose transformation;
mapping pixel values of the source image onto corresponding target pixel locations; and
generating the first reconstructed target image based on the mapped pixel values.

7. The method of claim 6, wherein mapping the pixel values of the source image onto the corresponding target pixel locations includes determining a pixel value using bilinear sampling of pixel values from adjacent pixel locations of the source image if a transformed target pixel location does not fall into an integer pixel location in the source image.

8. The method of claim 1, wherein the forward warping comprises:
projecting a plurality of depth values from the source image into a 3D space based on the source depth map and a set of camera intrinsic parameters;
generating a pose transformation from the source image to the target image by reversing the pose transformation from the target image to the source image;
transforming positions of the projected depth values, based on the pose transformation from the source image to the target image; and
mapping the transformed depth values onto the second reconstructed target depth map based on the set of camera intrinsic parameters.

9. The method of claim 8, wherein the mapping the transformed depth values onto the second reconstructed target depth map includes determining a minimum depth value from an occluded set of depth values and discarding other depth values in the occluded set if the occluded set of depth values are mapped onto a single pixel location of the second reconstructed target depth map.

10. A non-transitory computer-readable media storing computer instructions that configure at least one processor, upon execution of the instructions, to perform the following steps:
estimating a target depth map or a target image in a time series of two or more images;
estimating a pose transformation from the target image to a source image, adjacent to the target image in the time series;
backwards warping the source image to generate a first reconstructed target image, based on the pose transformation and the target depth map;
calculating an initial image reconstruction loss, based on the target image and the first reconstructed target image;
estimating a source depth map for the source image;
forward warping the source depth map to generate a second reconstructed target depth map, based on the pose transformation and the source depth map;
generating an occlusion mask by the second reconstructed target depth map, the occlusion map indicating one or more occluded areas of the target image; and
regularising the initial image reconstruction loss based on the generated occlusion mask to generate a regularised image reconstruction loss.

11. The computer-readable media of claim 10, wherein the estimating the target depth map and the source depth map uses a first neural network.

12. The computer-readable media of claim 10, wherein the computer instructions further configure the at least one processor, upon execution of the instructions, to perform training the first neural network based on the regularised image reconstruction loss.

13. The computer-readable media of claim 10, wherein the estimating the pose transformation uses a second neural network.

14. The computer-readable media of claim xx, wherein the computer instructions further configure the at least one processor, upon execution of the instructions, to perform training the second neural network based on the regularised image reconstruction loss.

15. The computer-readable media of claim 10, the backwards warping comprising:
projecting a plurality of target pixel locations of the target image into a 3D space, based on the target depth map and a set of camera intrinsic parameters;
transforming positions of the projected pixel locations to the source image, based on the pose transformation;
mapping pixel values of the source image onto corresponding target pixel locations; and
generating the first reconstructed target image based on the mapped pixel values.

16. The computer-readable media of claim 15, wherein mapping the pixel values of the source image onto the corresponding target pixel locations includes determining a pixel value using bilinear sampling of pixel values from adjacent pixel locations of the source image if a transformed target pixel location does not fall into an integer pixel location in the source image.

17. The computer-readable media of claim 10, wherein the forward warping comprises:
projecting a plurality of depth values from the source image into a 3D space based on the source depth map and a set of camera intrinsic parameters;
generating a pose transformation from the source image to the target image by reversing the pose transformation from the target image to the source image;
transforming positions of the projected depth values, based on the pose transformation from the source image to the target image; and
mapping the transformed depth values onto the second reconstructed target depth map based on the set of camera intrinsic parameters.

18. The computer-readable media of claim 17, wherein the mapping the transformed depth values onto the second reconstructed target depth map includes determining a minimum depth value from an occluded set of depth values and discarding other depth values in the occluded set if the occluded set of depth values are mapped onto a single pixel location of the second reconstructed target depth map.
